(19) United States
(12) Patent Application Publication
(10) Pub. No.: US 2014/0347458 A1
(43) Pub. Date: Nov. 27, 2014

(54) CELLULAR PHONE CAMERA FOR DRIVER STATE ESTIMATION

(71) Applicant: FORD GLOBAL TECHNOLOGIES, LLC, Dearborn, MI (US)

(72) Inventors: Louis Tijerina, Dearborn, MI (US); Dev Singh Kochhar, Ann Arbor, MI (US); Walter Joseph Talamonti, Dearborn, MI (US)

(73) Assignee: FORD GLOBAL TECHNOLOGIES, LLC, Dearborn, MI (US)

(21) Appl. No.: 13/900,593

(22) Filed: May 23, 2013

(51) Int. Cl. G06K 9/00; H04N 7/18

(52) U.S. Cl. CPC G06K 9/00369; H04N 7/183
USPC 348/77

(57) ABSTRACT

A method of monitoring a driver of a vehicle includes positioning a cellular telephone within a vehicle such that a camera of the cellular telephone views a driver's head, executing application software on the cellular telephone to capture images of the head using the camera, categorizing a pose of the head from the captured images, and affecting at least one safety system of the vehicle based on the categorization.

### BACKGROUND

Driver distraction and fatigue can lead to accidents or near misses while driving at night or on extended trips. Driver distraction and fatigue can often be detected by detecting eye glance behavior away from the road or by eyelid closure. However, such behavior can be difficult to detect in a dark environment or when the driver is wearing sunglasses, a hat, or a baseball cap, as examples. Alternatively, head rotation or head drop may be detected as an indicator of driver fatigue as a surrogate to eye glances away from the road scene. Thus, head pose tracking systems have been developed for providing an indicator that the driver may be fatigued. However, such systems tend to be costly, and cumbersome to build and operate.

### SUMMARY

A method of monitoring a driver of a vehicle includes positioning a cellular telephone within a vehicle such that a camera of the cellular telephone views a driver's head, executing application software on the cellular telephone to capture images of the head using the camera, categorizing a pose of the head from the captured images, and affecting at least one safety system of the vehicle based on the categorization.

A vehicle includes a holder for a cellphone, wherein when the cellphone is placed in the holder a camera within the cellphone is directed toward a driver head region. The cellphone includes a software application programmed to capture images of the driver head region with the camera, send the images to a computing device. The computing device is programmed to categorize a head pose using the captured images, and send commands to a safety system of the vehicle to affect operation of the safety system based on the categorization.

A system for monitoring a driver of a vehicle includes a holder, a computing device, and a cellphone positioned in the holder. The cellphone includes a camera and application software that is programmed to obtain images of a head of the driver of the vehicle, and send the images to the computing device. The computing device is programmed to categorize a pose of the head from the images, and affect at least one safety system of the vehicle based on the categorization.

### BRIEF DESCRIPTION OF THE DRAWINGS

FIG. 1 illustrates a vehicle that incorporates embodiments of the disclosed system;

FIG. 2 illustrates elements of a dashboard and alternative embodiments of the disclosed system; and

FIG. 3 illustrates a method of monitoring a driver according to one exemplary embodiment.

### DETAILED DESCRIPTION

The illustrative embodiments include monitoring a driver using a vehicle based workload estimator for monitoring driver wellness by taking advantage of controls including, but not limited to, sensors, microcontroller units (MCUs), microprocessors, Digital Signal Processors (DSPs), analog front ends, memory devices, power Integrated Circuits (ICs), and transmitters and receivers which may already exist in a vehicle or which can be conveniently connected to the existing systems on a vehicle.

Assessing or estimating a driver physiological and emotional state is one potential use of an automotive based workload estimator. An integrated automotive biometric system allows inference or estimation of driver states including, but not limited to, cognitive, emotional, workload and fatigue, which may augment decision-making Such monitoring may facilitate improved driver safety measures. The driver's state can be used, for example, as input to warn the driver and/or other vehicle occupants, and/or to send messages to appropriate health care professionals through, for example, wireless transmission. This data can be used to provide assistance to a driver if needed.

The illustrative embodiments may be used to target medical devices to provide driver health monitoring. In one example, the system utilizes portable home medical equipment, which patients may already own. This equipment may be carried with a patient while the patient is driving or riding in a vehicle. A monitored health state may be transmitted to an MCU through BLUETOOTH, ZigBee, or other appropriate protocol.

Warning thresholds may be pre-defined and stored in memory in the devices, or the thresholds may be stored in a local vehicle computing system or on a remote server. In one example, once a certain device's presence is detected, a vehicle computing system may be operable to download corresponding thresholds, which can be predetermined or even based on a specific patient setup.

The MCU may monitor the health state against preset thresholds. It may present a warning message to a driver via a vehicle computing system or other device, if a warning threshold is passed. The data can also be sent/uploaded to a remote source via a wireless connection to a remote server. Additionally or alternatively, in an extreme situation, for example, vehicle control may be co-opted by an automatic drive system and the vehicle may be safely guided to a roadside if a driver emergency occurs.

In a further illustrative embodiment, the system may monitor built-in non-intrusive health monitoring devices to monitor the driver's wellness state for safe driving. These devices may include, but are not limited to, heart rate monitors, temperature monitors, respiration monitors, etc. Such a health monitoring and wellness system may be used to warn drivers, wake drivers, or even prevent a vehicle from being started in the first place if a critical condition is present, for example. As will be further illustrated, such a device may be used to monitor a driver for fatigue and affect system safety parameters and other vehicle devices if signs of fatigue are detected.

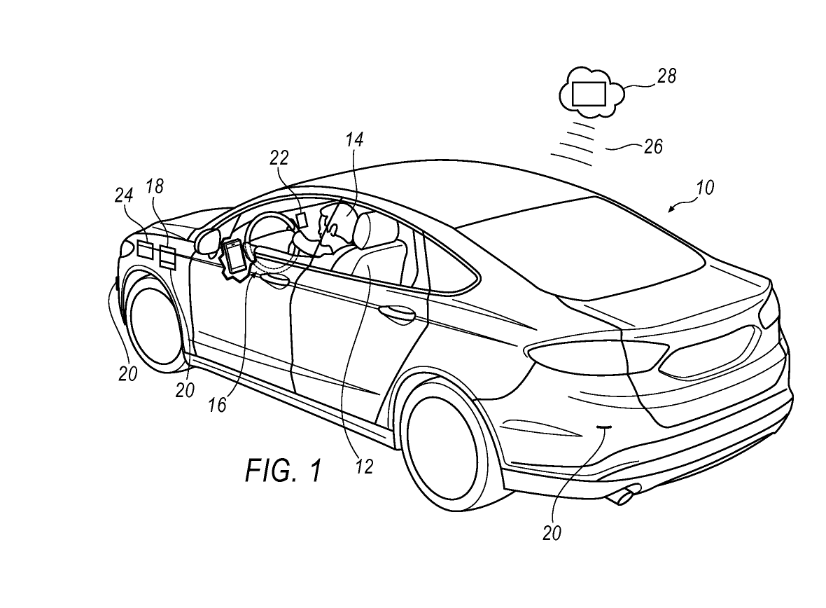

FIG. 1 shows a vehicle 10 that incorporates a system and method of monitoring a driver of a vehicle for fatigue. Vehicle 10 is illustrated as a typical 4-door sedan, but may be any vehicle for driving on a road, such as a compact car, a pickup truck, or a semi-trailer truck, as examples. Vehicle 10 includes a seat 12 for positioning a driver such that the driver's head or head region 14 is faced forward during driving. Vehicle 10 includes a dashboard 16 that typically includes control buttons or switches for activating various devices on vehicle 10. A steering wheel 16 is positioned such that the driver can steer vehicle 10 while driving.

Vehicle 10 includes a number of safety features, which include but are not limited to an airbag system 18, various sensors 20 throughout vehicle 10, and an audio/visual system 22. Airbag system 18 is typically controlled by a controller or computer or computing device 24 positioned within vehicle 10, and system 18 controls deployment of airbags (not shown) that are positioned within the compartment in which the driver and passengers sit. Sensors 20 may be positioned external to vehicle 10 and may be used to detect other vehicles that are proximate vehicle 10, or may be used to detect sudden vehicle deceleration, as an example, during an event that may trigger the airbags. System 22 may include an audio and/or visual device for warning a driver or other occupant of a car of a hazard, for instance.

That is, system 22 may be coupled to or a part an integrated automotive system that monitors a driver and infers a state of the driver, which may include cognitive, emotional, workload, and fatigue, as examples, to augment decision making for operation of the vehicle. Such monitoring may facilitate improved driver safety measures and the driver's inferred state can be used as input to warn the driver, other occupants of the vehicle, or to send warning signals wirelessly 26 external to the vehicle, such as to a “cloud computing” device or collection of computers or computing devices 28. In addition, the inferred state of the driver may be used to alter safety features or settings of such features, such as an airbag setting, a sensor configuration of the vehicle 20, and a warning system.

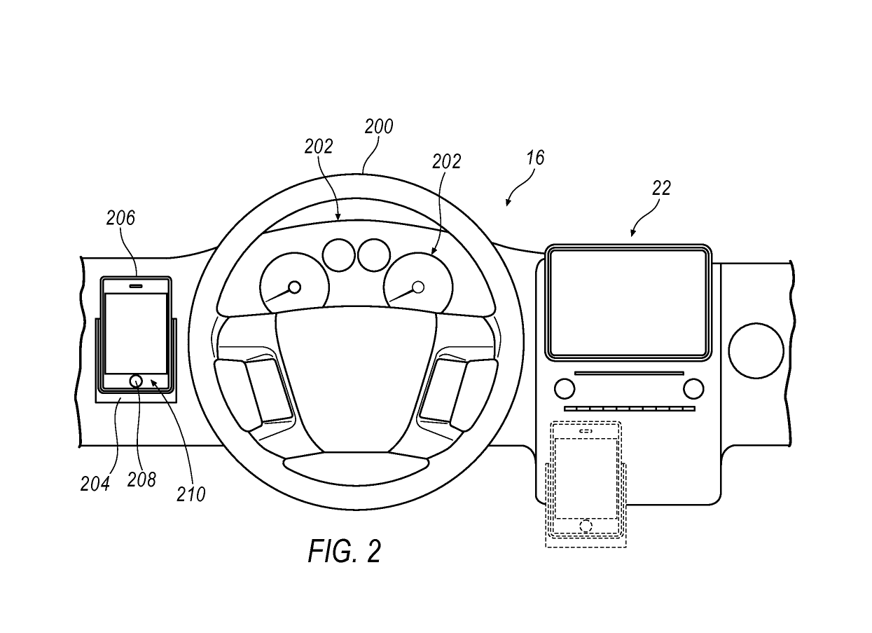

Referring to FIG. 2, dashboard 16 includes a steering wheel 200 and instruments 202 that display vehicle speed, engine speed (e.g., in a tachometer), and the like. Dashboard 16 includes a holder 204 to which a cellphone or cellular telephone 206 is attached. Holder 204 includes any device for holding cellphone 206, such as a clamping device, Velcro, or a device with slots into which cellphone 206 slides, as examples. In addition to conventional cellphone communication capability (e.g., for telephone calls) cellphone 206 includes a wireless communication device such as Bluetooth or other known methods for communicating with a local device such as a vehicle 10. Such may be useful for sending music or other information for use on a sound system of vehicle 10, or for communicating with a safety system of vehicle 10. Cellphone 206 in one embodiment is a “smartphone” that is capable of executing software applications, or “apps” that interact with the internet via a touchscreen or other known methods. Cellphone 206 includes a camera 208 that can view a head of the driver, such as head 14 as described with respect to FIG. 1. In one embodiment, cellular telephone 206 includes camera 208 having a lens on a first face 210 of the cellular telephone that is positioned toward head 14 of the driver, and at least one of a keypad and display on a second face of the cellular telephone that is opposite the first face.

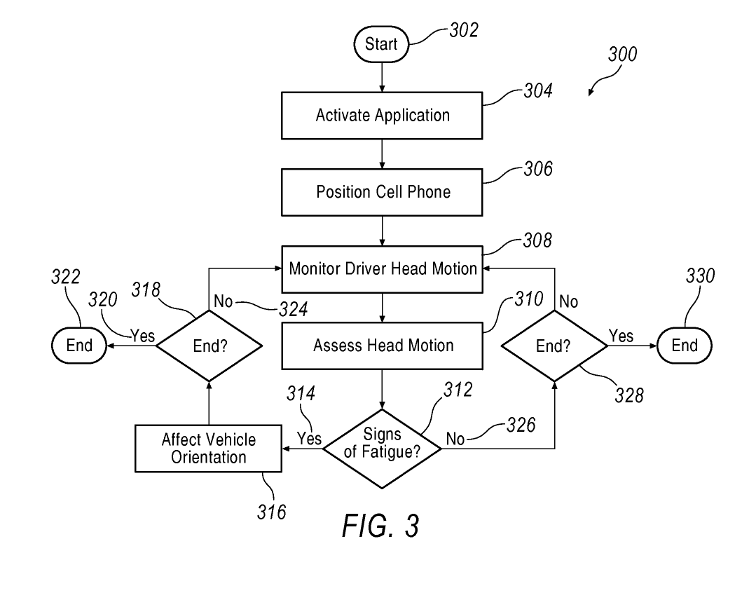

Referring to FIG. 3, a method 300 is shown for monitoring a driver of a vehicle. Starting at step 302, an application on cellphone 206 is activated or executed at step 304. The application executed causes camera 208 to activate and view the surroundings. As such, cellphone 206 is positioned within holder 204 at step 306 such that head 14, within vehicle 10, is visible to camera 208 and images (as a video stream or as a series of stationary images) are captured using camera 208. Driver head pose or motion is monitored at step 308 via the images captured, and head motion is assessed at step 310. Head pose assessment may be performed using software that identifies or categorizes the images to detect signs of driver fatigue using the images of the head, such as prolonged periods of no head motion, sagging head position (identified by location of the chin, nose, or other identifiable features on the face of head 14), tilt of head 14, and the like. That is, images are assessed at step 310 for signs of fatigue at step 312. Such assessment may be within an algorithm as part of the application itself on cellphone 206, or may be an algorithm within another computing device with which cellphone 206 is in communication. Such may be computer 24 of vehicle 10, or may be computing devices 28 that are external to vehicle 10. If the assessment or categorization is performed using computer 24 of vehicle 10, then the captured images are sent wirelessly from cellphone 206 to computer 24. If the assessment or categorization is performed using an algorithm that is executed within a computer that is external to the vehicle, then the head images are sent wirelessly to the computer external to the vehicle.

If signs of fatigue are detected 314, then safety systems of vehicle 10 may be affected or otherwise altered at step 316 to account for driver fatigue. Such systems may include an airbag setting or a sensor configuration. For instance, when affecting the airbag settings, reaction time or other parameters of the airbag may be altered as a condition of the current vehicle operation (e.g., vehicle speed). When affecting the sensor configuration, sensors 20, for instance, may be altered to detect a wider scanning view window if the vehicle is travelling at a relatively high rate of speed. Thus, if driver fatigue is detected, vehicle system parameters may be affected, and such parameters are not limited to those listed herein, but can apply to any safety systems that may be desirable to alter if driver fatigue is detected.

In addition, an alert may be sent to the driver or others external to the vehicle if driver fatigue is detected. For instance, a visual warning may be displayed on system 22 and/or an audio warning signal may be activated. Such may be in the form of a computer-generated voice or in the form of an alarm, as examples. In one example, an autodial feature may be activated to call for assistance using cellular telephone 206.

Further, in one embodiment, vehicle 10 may be operating in an autonomous mode and without direct driver interaction. In autonomous mode, the driver of vehicle 10 may activate autonomous operation in which sensors, such as sensors 20 and the like, detect vehicle position on a road and also may access a computer base having a roadmap, realtime weather conditions, and the like. In such operation, the vehicle “drives itself” via, for instance, computer 24 and controls the vehicle accelerator, vehicle brakes, and vehicle steering. The driver thereby turns over control of the vehicle to the computer and without having direct control of the vehicle. The driver may override autonomous operation by a number of methods that include but are not limited to touching the brakes, grabbing the steering wheel, touching the accelerator, or by a voice command.

Thus, at step 316, if signs of fatigue are detected, then vehicle operation may be affected by altering safety settings of the vehicle, alerting the driver, or removing the vehicle from autonomous operation to turn the vehicle over to active human driver operation.

If signs of fatigue have been detected, method 300 may be assessed whether to end at step 318 if the driver instructs the program or app to discontinue such monitoring, and if so 320, then the method ends at step 322. If not directed to end 324 after fatigue has been detected, then the program continues and control is returned to step 308. Further, returning to step 312, if signs of fatigue are not detected 326, then assessment may also occur at step 328 to determine whether to end 330 or continue monitoring for fatigue and return control to step 308.

Computers 24 and/or 28 may include a computer or a computer readable storage medium implementing all or portions of method or algorithm 300. For instance, once images are obtained by cellphone 206, then further steps of method 300 may be performed either by the app itself in cellphone 206, or within computers 24 and/or 28.

In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OS X and iOS operating systems distributed by Apple Inc. of Cupertino, Calif., and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method of monitoring a driver of a vehicle, comprising:
positioning a cellular telephone within a vehicle such that a camera of the cellular telephone views a driver's head;
executing application software on the cellular telephone to capture images of the head using the camera;
categorizing a pose of the head from the captured images; and
affecting at least one safety system of the vehicle based on the categorization.

2. The method of claim 1, further comprising:
wirelessly sending the images of the head to the vehicle; and
categorizing the pose of the head using an algorithm that is executed within a computer of the vehicle.

3. The method of claim 1, further comprising:
wirelessly sending the images of the head to a system that is external to the vehicle; and
categorizing the pose of the head using an algorithm that is executed within a computer that is external to the vehicle.

4. The method of claim 3, wherein the computer that is external to the vehicle is a cloud network of one or more computers.

5. The method of claim 1, wherein affecting the at least one safety system comprises altering at least one of an airbag setting, a sensor configuration of the vehicle, and a warning system.

6. The method of claim 5, wherein the warning system comprises one of an audio signal or a visual signal within the vehicle, and an autodial feature to call for assistance using the cellular telephone.

7. The method of claim 1, wherein affecting the at least one safety system comprises altering the vehicle from an autonomous operation to an active human driver operation.

8. The method of claim 1, wherein positioning the cellular telephone comprises positioning the cellular telephone within a holder on a dashboard of the vehicle.

9. The method of claim 8, wherein the cellular telephone includes the camera having a lens on a first face of the cellular telephone that is positioned toward the head of the driver, and at least one of a keypad and display on a second face of the cellular telephone that is opposite the first face.

10. A vehicle, comprising:
a holder for a cellphone, wherein:
when the cellphone is placed in the holder, a camera within the cellphone is directed toward a driver head region; and
the cellphone includes a software application programmed to:
capture images of the driver head region with the camera;
send the images to a computing device; and
wherein the computing device is programmed to:
categorize a head pose using the captured images; and
send commands to a safety system of the vehicle to affect operation of the safety system based on the categorization.

11. The vehicle of claim 10, wherein the cellphone includes a lens of the camera on a first face of the cellphone that is directed toward the head of the driver, and at least one of a keypad and display on a second face of the cellphone that is opposite the first face.

12. The vehicle of claim 10, wherein the computing device is located external to the vehicle.

13. The vehicle of claim 10, wherein the vehicle is configured to operate autonomously and without a human driver, and wherein the commands sent to the safety system include removing operation of the vehicle from autonomous operation such that control of the vehicle is returned to the human driver.

14. The vehicle of claim 10, wherein the safety system comprises at least one of an airbag setting, a sensor configuration of the vehicle, and a warning system.

15. The vehicle of claim 10, wherein the cellphone includes the camera having a lens on a first face of the cellular telephone that is positioned toward the driver head region, and at least one of a keypad and display on a second face of the cellular telephone that is opposite the first face.

16. A system for monitoring a driver of a vehicle, comprising:
a holder;
a computing device;
a cellphone positioned in the holder, the cellphone having a camera and application software that is programmed to:
obtain images of a head of the driver of the vehicle; and
send the images to the computing device;
wherein the computing device is programmed to:
categorize a pose of the head from the images; and
affect at least one safety system of the vehicle based on the categorization.

17. The system of claim 16, wherein the computing device is positioned within the vehicle, and the at least one safety system of the vehicle is at least one of an airbag setting, a sensor configuration of the vehicle, and a warning system.

18. The system of claim 16, wherein the computing device is positioned external to the vehicle, and the at least one safety system of the vehicle is at least one of an airbag setting, a sensor configuration of the vehicle, and a warning system.

19. The system of claim 18, wherein the computer is a cloud network of one or more computers.

20. The system of claim 16, wherein the cellphone is positioned within the holder on a dashboard of the vehicle, and wherein the cellular telephone includes the camera having a lens on a first face of the cellular telephone that is positioned toward the head of the driver, and at least one of a keypad and display on a second face of the cellular telephone that is opposite the first face.
